(19) United States
(12) Patent Application Publication
(10) Pub. No.: US 2013/0118280 A1
(43) Pub. Date: May 16, 2013

(54) GYROSCOPE AND METHOD FOR MANUFACTURING THE SAME

(71) Applicants: Jianhong Mao, Shanghai (CN); Fengqin Han, Shanghai (CN); Deming Tang, Shanghai (CN)

(72) Inventors: Jianhong Mao, Shanghai (CN); Fengqin Han, Shanghai (CN); Deming Tang, Shanghai (CN)

(73) Assignee: LEXVU OPTO MICROELECTRONICS TECHNOLOGY (SHANGHAI) LTD, Shanghai (CN)

(21) Appl. No.: 13/703,506

(22) PCT Filed: Jan. 26, 2011
(86) PCT No.: PCT/CN11/70635

§ 371 Date: Jan. 28, 2013

(30) Foreign Application Priority Data
Jun. 11, 2010 (CN) 201010200715.3

(51) Int. Cl. G01C 19/04

(52) U.S. Cl. CPC G01C 19/04
USPC 74/5.7; 74/5.95; 216/17

(57) ABSTRACT

A gyroscope and a manufacturing method are provided. The gyroscope comprises: a substrate with a bottom driving electrode and a bottom measuring electrode, and a dielectric layer with a sealed cavity comprising: a central axis on the substrate; a support ring on the substrate rotatable around the central axis; a mass ring surrounding and having common central axis with the support ring; cantilevers connected with the support ring and the mass ring and suspend the mass ring in the cavity; elastic components among the support ring, the mass ring and two adjacent cantilevers; a top driving electrode overlaying the support ring, the mass ring, the cantilevers and the elastic components; a conductive plug connected with top driving electrode and bottom driving electrode on the elastic components. The mass ring comprises an insulation layer and a weight layer. Stability and performance of the gyroscope may be improved.

### CROSS-REFERENCE TO RELATED APPLICATIONS

The present application claims the priority of Chinese Patent Application No. 201010200715.3, entitled “Gyroscope and method for manufacturing the same”, and filed on Jun. 11, 2010, the entire disclosure of which is incorporated herein by reference.

### FIELD OF THE DISCLOSURE

The present invention relates to semiconductor manufacturing technology, and particularly relates to a gyroscope and method of fabricating the same.

### BACKGROUND OF THE DISCLOSURE

A gyroscope can accurately determine the position of a moving object, and is widely used in modern aviation, navigation, aerospace and national defense industry as an inertial navigation device. The development of gyroscope is very important to the industry, national defense and other high-tech industries of a country. A traditional gyroscope mainly refers to a mechanical inertial gyroscope, which is complex and has high requirements on the process, so the accuracy is affected by many factors.

As shown in FIG. 1, a prior art vibratory double-axially sensing micro-gyroscope includes a base 54, on center of which a supporting hub 55 is arranged, and plural suspending arms 52 are extended outwardly with equal altitude and in radial direction from the supporting hub 55. An inside end 521 of the suspending arm 52 is connected to the supporting hub 55, and an outside end 552 of the suspending arm 52 is extended horizontally toward two sides by taking the suspending arm 52 as center to form a platform 523. Two ends of the top of the platform 523 are respectively arranged a metallic capacitance sensing electrode 51 which works as an inertia mass block of the gyroscope. A static-electricity driving electrode 53 is arranged under the platform 523. When the static-electricity driving electrode 53 is driven by a voltage, the suspending arm 52 and the platform 523 are attracted by the static-electricity to vibrate in Z direction, and the vibration phase difference between two adjacent suspending arms 52 and the platform 523 is 180 degrees. When the gyroscope is rotated in X direction or Y direction, the suspending arm 52 and the platform 523 generate displacements in X direction or Y direction because of Coriolis force. The capacitance sensing electrode 51 generates different values of capacitance, because the distance between two electrodes is changed.

The magnitude of the rotary angular speed subjected by gyroscope may be obtained by measuring the change of the capacitance values. Besides, US patent No.005747690A also discloses a vibratory micro-gyroscope.

The higher the quality of the inertia mass block of the gyroscope described above, the greater the inertia, and the stability and anti-environmental noise capability of the gyroscope. However, because of the limitation of the semiconductor manufacturing technology, it is unable to integrate a gyroscope with a high-quality inertia mass block into an integrated circuit.

### BRIEF SUMMARY OF THE DISCLOSURE

An object of the present invention is to provide a gyroscope, for improving stability and anti-environmental noise capability.

To achieve the project, the present invention provides a gyroscope which comprises a substrate, a dielectric insulating layer, a supporting ring, a ring-typed planar inertia, plural suspending arms, plural elastic components, plural top driving electrodes, and plural conductive plugs. The substrate comprises plural bottom driving electrodes and plural bottom measuring electrodes around the bottom driving electrodes. The dielectric insulating layer is arranged on the substrate and comprises a closed cavity which comprises a supporting hub arranged on the substrate. The supporting ring is arranged on the substrate and can rotate around the supporting hub. The ring-typed planar inertia is around and has the same central axis with the supporting ring. The suspending arms connect the supporting ring with the ring-typed planar inertia. The ring-typed planar inertia is suspended in the closed cavity and supported by the suspending arms. The elastic components are surrounded by the supporting ring, the ring-typed planar inertia and two adjacent suspending arms. The top driving electrodes cover the supporting ring, the ring-typed planar inertia, the suspending arms and the elastic components. The conductive plugs connect the top driving electrodes to the bottom driving electrodes. The ring-typed planar inertia comprises a first insulating layer and a weighting layer under the first insulating layer.

Optionally, the weighting layer is ring-typed.

Optionally, the weighting layer comprises a plurality of weighting columns distributed symmetrically on a ring.

Optionally, the weight of the weighting layer is greater than the weight of the first insulating layer.

Optionally, the weighting layer is made of tungsten.

Optionally, the conductive plugs are made of tungsten.

Optionally, the supporting ring comprises a supporting layer which is made of the same material with the weighting layer and a second insulating layer at the top of the supporting layer. The second insulating layer and the first insulating layer are in the same plane.

Optionally, the suspending arms are extended outwardly with equal altitude and in radial direction from the supporting ring, and suspended in the closed cavity.

Optionally, one end of every elastic component connects to an adjacent suspending arm, and the other end connects to a conductive plug.

Optionally, the ring-typed planar inertia has the supporting hub as center, connects to free ends of the suspending arms, and is suspended over the bottom measuring electrodes in the closed cavity supported by the suspending arms.

Optionally, the top driving electrodes cover the supporting ring, the ring-typed planar inertia, the suspending arms and the elastic components. The top driving electrodes which are at the top of the supporting ring and the ring-typed planar inertia comprise four insulating parts, and connect to the bottom driving electrodes through the conductive plugs.

Furthermore, the present invention provides a method of fabricating the gyroscope described above. The method is described as follows.

Providing a substrate. The substrate comprises plural bottom driving electrodes and plural bottom measuring electrodes. A first dielectric insulating layer is at the top of the substrate and comprises a ring-typed groove. A first part of a supporting hub is at the center of the ring-typed groove. Plural columned bodies are inside the ring-typed groove and at the top of the bottom driving electrodes.

Depositing the ring-typed groove with a first sacrificial material until the top of the first sacrificial material and the columned bodies are in the same plane.

Etching the first sacrificial material to form a first groove and a second groove inside the first sacrificial material. The first groove is arranged over the ring formed by the bottom driving electrodes. The second groove is arranged between the columned bodies and the first part of the supporting hub.

Etching the columned bodies to form through vias which expose the bottom driving electrodes.

Depositing the first groove to form a weighting layer of a ring-typed planar inertia, depositing the second groove to form a first part of a supporting ring, and depositing the through vias to form conductive plugs.

Providing a first insulating layer on the supporting ring and the weighting layer. The first insulating layer and the weighting layer constitute the ring-typed planar inertia. The first insulating layer and the first part of the supporting layer constitute the supporting layer.

Providing at least a suspending arm which connects the ring-typed planar inertia with the supporting ring. The suspending arms are extended outwardly with equal altitude in radical direction by taking the supporting hub as center. Provide elastic components between the ring-typed planar inertia and the supporting ring.

Providing top driving electrodes at the top of the ring-typed planar inertia, suspending arms, conductive plugs and the elastic components.

Providing a second part of the supporting hub on the first part of the supporting hub. The first part and the second part of the supporting hub constitute the supporting hub. Provide a second insulating layer on the first insulating layer.

Providing a second sacrificial material at the top the first sacrificial material and the top driving electrodes.

Providing a third dielectric insulating layer at the top of the second sacrificial material and the supporting ring. The third dielectric insulating layer comprises openings.

Removing the first and second sacrificial material by utilizing the openings, and providing a fourth dielectric insulating layer at the top of the third dielectric insulating layer to form a closed cavity.

Optionally, the first groove is ring-typed.

Optionally, the first groove comprises a plurality of grooves symmetrically distributed on a ring.

Optionally, the weighting layer is made of tungsten.

Optionally, depositing the first groove to form the weighting layer, depositing the second groove to form the first part of the supporting ring and depositing the vias to form the conductive plugs could be finished in one process.

Compared with the prior art, the advantages of the present invention are as follows.

The gyroscope fabricated with the described method is closed in a closed cavity, whereby the stability is improved. A weighting layer is added to a planar inertia, thereby increasing the quality and inertia of the planar inertia. Furthermore, the supporting hub is closed, thereby improving the anti-environment noise capability of the gyroscope.

### BRIEF DESCRIPTION OF THE DRAWINGS

The invention will become more readily apparent from the following description, by way of example, in the accompanying drawings wherein corresponding or like numerals and characters indicate corresponding or like components.

FIG. 1 schematically shows a o prior art gyroscope;

FIG. 2 is a top view of a gyroscope according to the present invention;

FIG. 3a shows a cross section view taken along A-A′ of FIG. 2;

FIG. 3b shows a cross section view taken along B-B′ of FIG. 2;

FIG. 3c shows a cross section view taken along C-C′ of FIG. 2;

FIG. 4 shows a flow chart of the method of fabricating the gyroscope according to the present invention;

FIG. 5 to FIG. 14 show schematic diagrams of the method of fabricating the gyroscope according to present invention.

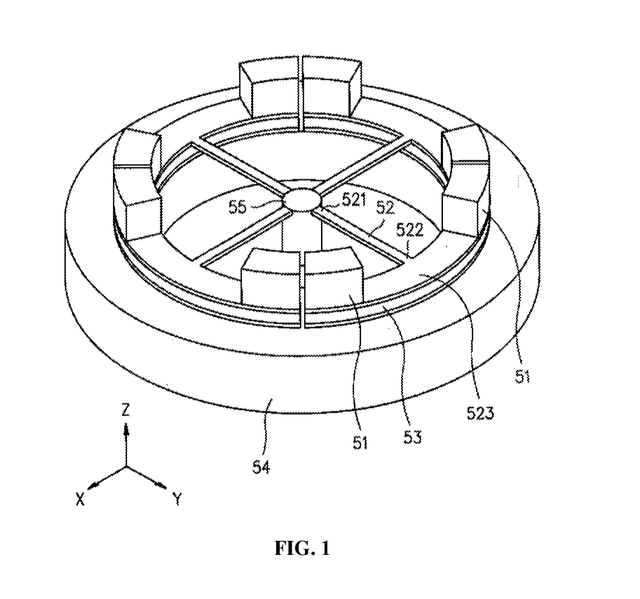

### DETAILED DESCRIPTION OF THE DISCLOSURE

According to the prior art, every gyroscope provides a planar inertia. The higher the quality of the planar inertia, the greater the inertia, and the stability and anti-environmental noise capability of the gyroscope. However, because of the limitation of the semiconductor manufacturing technology, it is unable to integrate a gyroscope with a high quality planar inertia into an integrated circuit.

The present invention provides a gyroscope which comprises a substrate, a dielectric insulating layer, a supporting ring, a ring-typed planar inertia, plural suspending arms, plural elastic components, plural top driving electrodes, and plural conductive plugs. The substrate comprises plural bottom driving electrodes and plural bottom measuring electrodes around the bottom driving electrodes. The dielectric insulating layer is arranged on the substrate and comprises a closed cavity which comprises a supporting hub arranged on the substrate. The supporting ring is arranged on the substrate and can rotate around the supporting hub. The ring-typed planar inertia is around and has the same central axis with the supporting ring. The suspending arms connect the supporting ring with the ring-typed planar inertia. The ring-typed planar inertia is suspended in the closed cavity and supported by the suspending arms. The elastic components are surrounded by the supporting ring, the ring-typed planar inertia and two adjacent suspending arms. The top driving electrodes cover the supporting ring, the ring-typed planar inertia, the suspending arms and the elastic components. The conductive plugs connect the top driving electrodes to the bottom driving electrodes. The ring-typed planar inertia comprises a first insulating layer and a weighting layer under the first insulating layer.

Furthermore, the present invention provides a method of fabricating the gyroscope described above. The method is described as follows.

Providing a substrate. The substrate comprises plural bottom driving electrodes and plural bottom measuring electrodes. A first dielectric insulating layer is at the top of the substrate and comprises a ring-typed groove. A first part of a supporting hub is at the center of the ring-typed groove. Plural columned bodies are inside the ring-typed groove and at the top of the bottom driving electrodes.

Depositing the ring-typed groove with a first sacrificial material until the top of the first sacrificial material and the columned bodies are in the same plane.

Etching the first sacrificial material to form a first groove and a second groove inside the first sacrificial material. The first groove is arranged over the ring formed by the bottom driving electrodes. The second groove is between the columned bodies and the first part of the supporting hub.

Etching the columned bodies to form through vias which expose the bottom driving electrodes.

Depositing the first groove to form a weighting layer of a ring-typed planar inertia, depositing the second groove to form a first part of a supporting ring, and depositing the through vias to form conductive plugs.

Providing a first insulating layer on the supporting ring and the weighting layer. The first insulating layer and the weighting layer constitute the ring-typed planar inertia. The first insulating layer and the first part of the supporting layer constitute the supporting ring.

Providing at least a suspending arm which connects the ring-typed planar inertia and the supporting ring. The suspending arms are extended outwardly with equal altitude in radical direction by taking the supporting hub as center. Provide elastic components between the ring-typed planar inertia and the supporting ring.

Providing top driving electrodes at the top of the ring-typed planar inertia, suspending arms, conductive plugs and the elastic components.

Providing a second part of the supporting hub on the first part of the supporting hub. The first part and the second part of the supporting hub constitute the supporting hub. Provide a second insulating layer on the first insulating layer.

Providing a second sacrificial material at the top the first sacrificial material and the top driving electrodes.

Providing a third dielectric insulating layer at the top of the second sacrificial material and the supporting ring. The third dielectric insulating layer comprises openings.

Removing the first and second sacrificial material by utilizing the openings, and providing a fourth dielectric insulating layer at the top of the third dielectric insulating layer to form a closed cavity.

Compared with the prior art, the gyroscope fabricated with the described method is closed in a closed cavity, whereby the stability is improved. A weighting layer is added to a planar inertia, thereby increasing the quality and inertia of the planar inertia. Furthermore, the supporting hub is closed, thereby improving the anti-environment noise capability of the gyroscope.

In order to illustrate the spirit of the present invention more clearly, a detailed description of the preferred embodiments are as follows, taken in conjunction with the figures wherein corresponding or like numerals and characters indicate corresponding or like components. Furthermore, the cross section views showing the structures of a gyroscope will be disproportionately magnified on the purpose of illustrating more clearly. The preferred embodiments should not limit the protection scope of this invention. Besides, the real length, width and depth should be considered in manufacture.

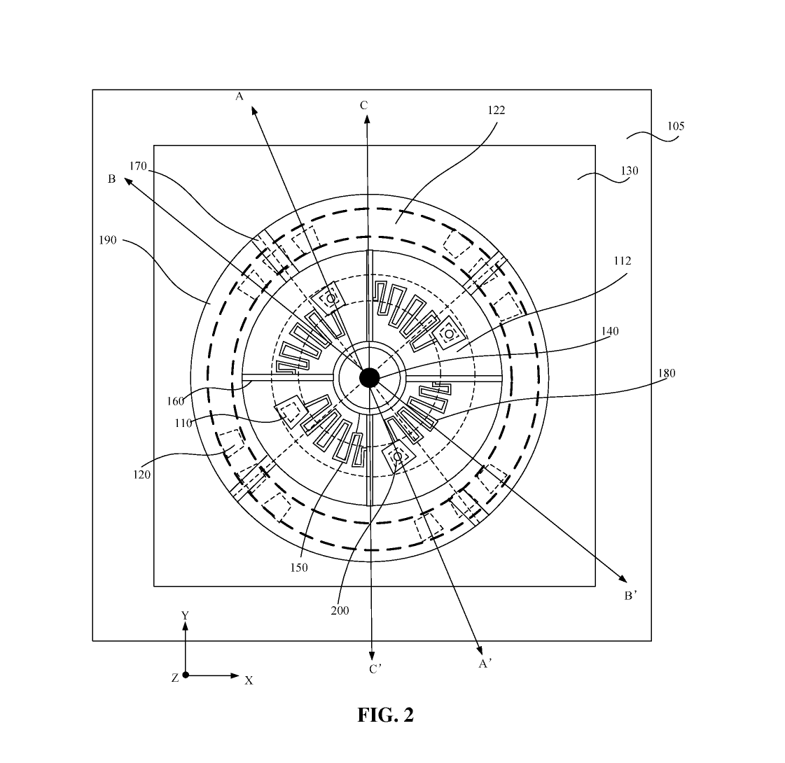

FIG. 2 shows the top view of a gyroscope according to the embodiment of the present invention. Referring to FIG. 2, a gyroscope comprises: a substrate(not shown in the figure), a closed cavity 130 arranged on the substrate, a supporting hub 140 in the closed cavity 130, a supporting ring 150, plural suspending arms 160, a ring-typed planar inertia 170 and plural elastic components 180. The supporting ring 150 is arranged on the substrate, with the supporting hub 140 as center and rotates around the supporting hub 140. The ring-typed planar inertia 170 surrounds and has the same center with the supporting ring 150. The suspending arms 160 connect the supporting ring 150 to the ring-typed planar inertia 170. The ring-typed planar inertia 170 suspends in the closed cavity 130 supported by the suspending arms 160. The elastic components 180 are arranged between the supporting ring 150 and the ring-typed planar inertia 170, and have the effect of recovery from stretching when the planar inertia 170 is rotating. The number of the elastic components 180 is corresponding to the number of the suspending arms 160. One end of every elastic component is connected to an adjacent suspending arm and the other end is free.

The gyroscope further comprises plural bottom driving electrodes 110, plural bottom measuring electrodes 120 and plural top driving electrodes 190. The bottom driving electrodes 110 and bottom measuring electrodes 120 are arranged in the substrate. The bottom driving electrodes 110 are distributed on a first ring 112 having the supporting hub 140 as center, and the bottom measuring electrodes 120 are distributed on a second ring 122 having the supporting hub 140 as center. The semidiameter of the second ring 122 is larger than the semidiameter of the first ring 112. The top driving electrodes 190 cover the ring-typed planar inertia 170, the suspending arms 160, the supporting rings 150 and plural elastic components 180, wherein the top driving electrodes 190 cover the ring-typed planar inertia 170 and the supporting rings 150 extend horizontally toward two sides by taking the suspending arms 160 as center, and are insulated to each other. The top driving electrodes 190 are connected to the bottom driving electrodes 110 through the conductive plugs 200 which is arranged on the free end of the elastic components 180.

The supporting hub according to this embodiment is closed, thereby improving the stability and anti-environment noise capability.

According to this embodiment, four suspending arms are symmetrically (with equal angles therebetween) arranged in four radial directions, thereby improving the balance of the gyroscope. In each fan-shaped region formed by two adjacent suspending arms 160 and the planar inertia 170, an elastic component 180 and a bottom driving electrode 110 are provided. In the substrate corresponding to the part of the planar inertia 170 between two adjacent suspending arms 160, three independent bottom measuring electrodes 120 are provided.

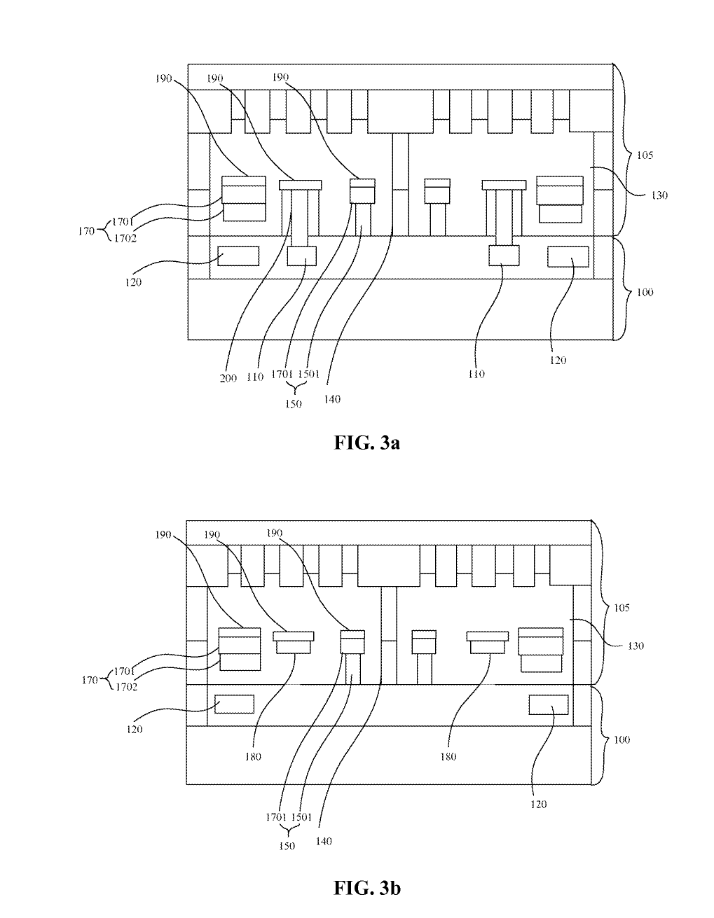

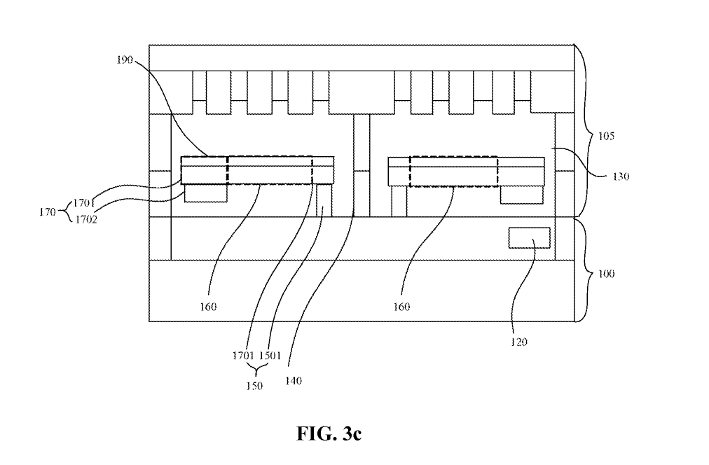

FIG. 3a shows the cross section view along A-A′, FIG. 3b shows the cross section view along B-B′, and FIG. 3c shows the cross section view along C-C′ of the gyroscope. Referring to FIGS. 3a, 3b and 3c, the gyroscope comprises: the substrate 100, the bottom driving electrodes 110, the bottom measuring electrodes 120, a dielectric insulating layer 105 which is provided at the top of the substrate 100, the closed cavity 130, the supporting hub 140, the supporting ring 150, the ring-typed planar inertia 170, the elastic components 180(referring to FIG. 3b), and the conductive plugs 200. The bottom driving electrodes 110 and the bottom measuring electrodes 120 are provided in the substrate 100. The semidiameter of the ring-typed planar inertia 170 is larger than the semidiameter of the supporting ring 150. The ring-typed planar inertia 170 is connected to the supporting ring 150 through the suspending arms 160(referring to FIG. 3c), and suspended in the closed cavity 130 supported by the suspending arms. One end of every elastic component 180 is connected to an adjacent suspending arm, and the other end is free. The top driving electrodes 190 cover the ring-typed planar inertia 170, the suspending arms 160, the supporting rings 150 and elastic components 180, wherein those cover the ring-typed planar inertia 170 and the supporting rings 150 extend horizontally toward two sides by taking the suspending arms 160 as center, and are insulated to each other. The conductive plugs 200 are provided on the free ends of the elastic component, and connect the bottom driving electrodes 110 to the top driving electrodes 190.

According to this embodiment, the dielectric insulating layer 105 is made of silicon oxide or silicon nitride.

The supporting hub in this embodiment is of laminated structure, but it may be of single-layer structure in other embodiments. The supporting hub is cylindrical in shape.

According to this embodiment, the supporting ring 150 may be of laminated or single-layer structure. When the supporting ring 150 is of laminated structure, the supporting ring 150 comprises a first metallic layer 1501 and a first insulating layer 1701. The first metallic layer 1501 is made of tungsten, and the first insulating layer 1701 is made of silicon oxide or silicon nitride.

According to this embodiment, the suspending arms comprise an insulating layer which is fixed on the first insulating layer 1701 of the supporting ring 150.

According to this embodiment, the ring-typed planar inertia 170 comprises a weighting layer 1702 and the first insulating layer 1701 which is at the top of the weighting layer 1702. The weighting layer 1702 could be a continuous ring or independent parts distributed on the ring of the first insulating layer 1701. The depth of the weighting layer 1702 could be 1 μm-3 μm, and the width along the radial direction could be 0.3 μm-2 μm. The width of the weighting layer 1702 could larger or smaller than the width of the first insulating layer 1701. The weighting layer 1702 could be made of the same material with the conductive plugs 200, and be manufactured in one process, thereby raising manufacture efficiency. Specifically, they could be made of any one or combination of tungsten, other metallic materials and non-metallic materials. Because of the weighting layer 1702 in the planar inertia 170, the inertia is increased, and the accuracy is improved. However, if the quality of the planar inertia is excessively large, the supporting ring and the suspending arms could be fractured. Preferably, the depth of the weighting layer 1702 is 1 μm-3 μm, and the width along the radial direction is 0.3 μm-2 μm. The supporting ring could be of laminated structure. The upper layer could be made of insulating materials, and the lower layer could be made of the same material with the weighting layer 1702. The width of the lower layer is 0.5 μm-10 μm, and the depth is 0.5 μm-20 μm. The width of the upper layer is 1 μm-10 μm, and the depth is 0.1 μm-3 μm. The suspending arms are made of silicon oxide or silicon nitride. The width of the suspending arms could be 1 μm-10 μm, and the depth is 0.1 μm-2 μm.

In this embodiment, the elastic components are springs. When the suspending arms 160 rotate around the supporting hub 140, the elastic components pull the suspending arms 160 to the opposite direction. The elastic components could be manufactured in the same process with the first insulating layer of the suspending arms, or it could be manufactured alone.

According to this embodiment, the weighting layer is added to a planar inertia, thereby increasing the quality and inertia of the planar inertia. Preferably, the weighting layer is made of tungsten having a high molecular weight, which enhances the effect. Besides, the process of manufacturing the weighting layer is compatible with manufacturing the conductive plugs and the metallic layer in the supporting ring, thereby simplifying the process. Furthermore, the supporting hub is closed, so the stability and anti-environment noise capability of the gyroscope are improved.

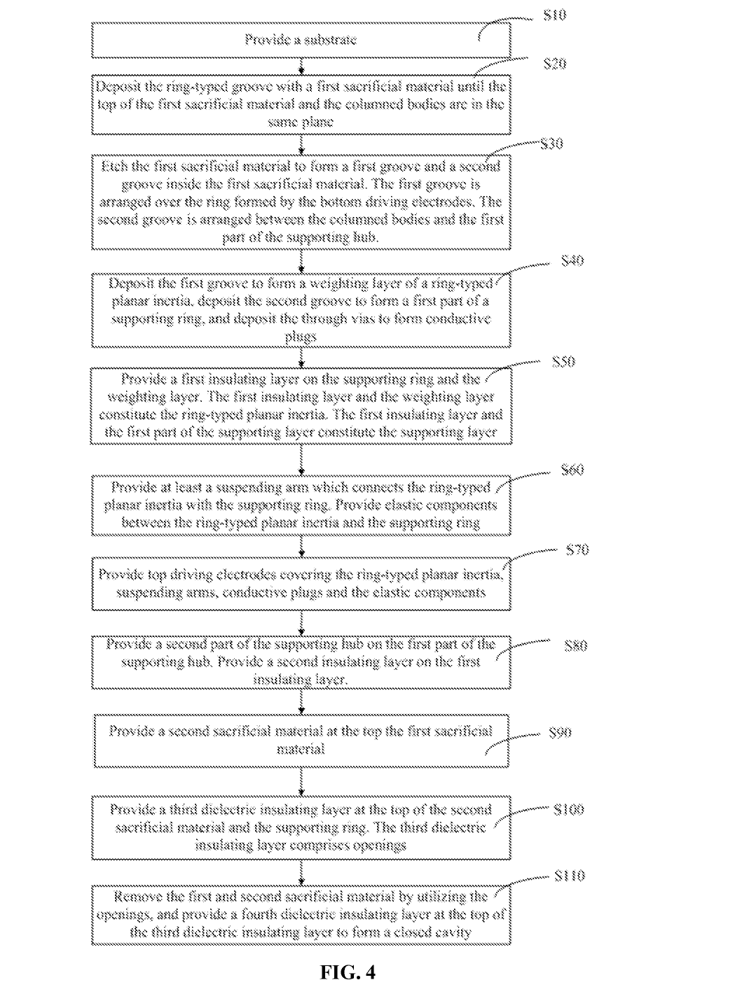

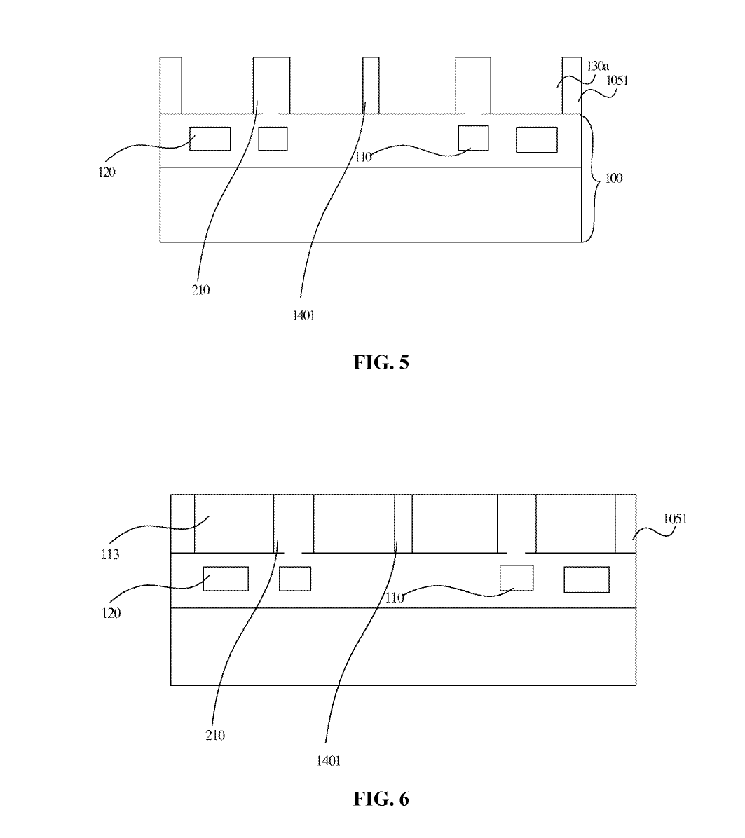

Correspondingly, the present invention further provides a method of fabricating the gyroscope described above. FIG. 4 shows the flow chart of the method of fabricating the gyroscope according to the embodiment. FIG. 5 to FIG. 14 show the schematic diagrams of the method of fabricating the gyroscope according to the present invention.

Referring to FIG. 4, a step S10 comprises: providing a substrate. The substrate comprises plural bottom driving electrodes and plural bottom measuring electrodes. A first dielectric insulation layer is at the top of the substrate and comprises a ring-typed groove. A first part of a supporting hub is at the center of the ring-typed groove. Plural columned bodies are inside the ring-typed groove and at the top of the bottom driving electrodes.

FIG. 5 schematically shows the structure formed by the step S10. The substrate 100 comprises plural bottom driving electrodes 110 and plural bottom measuring electrodes 120. The bottom driving electrodes 110 are distributed on a first ring, and the bottom measuring electrodes 120 are distributed on a second ring which has the same center with the first ring. The semidiameter of the second ring is larger than the semidiameter of the first ring. A first dielectric insulation layer 1051 is at the top of the substrate 100 and comprises a ring-typed groove 130a. A first part of a supporting hub 1401 is at the center of the ring-typed groove 130a. Plural columned bodies 210 are inside the ring-typed groove 130a and arranged over the bottom driving electrodes 120. The radius of the ring-typed groove 130a is larger than the radius of the second ring.

Referring to FIG. 4, a step S20 comprises: depositing the ring-typed groove with a first sacrificial material until the top of the first sacrificial material and the columned bodies are in the same plane.

FIG. 6 schematically shows the structure formed by the step S20. Deposit the ring-typed groove 130a with the first sacrificial material 113 by way of CVD, until the top surface of the first sacrificial material 113, the columned bodies 210 and the first dielectric insulating layer 1051 are in the same plane. Next, remove the unwanted first sacrificial material 113 by CMP. The first sacrificial material 113 could be carbon, germanium, or polyamide. Specifically, the first sacrificial material 113 is amorphous carbon, and the reaction conditions in plasma enhanced chemical vapor deposition (PECVD) are required. A temperature in the reaction ranges from 350 to 450° C. A pressure in the reaction ranges from 1 to 20 Torr. The RF power source outputs RF power ranging from 800 to 1500 W. The reaction gas includes C3H6 and HE, wherein the proportion between C3H6 and HE ranges from 2 to 5, and the gas flow rate ranges from 1000 sccm to 3000 sccm.

Referring to FIG. 4, a step S30 comprises: etching the first sacrificial material to form a first groove and a second groove inside the first sacrificial material. The first groove is arranged over the ring formed by the bottom driving electrodes. The second groove is between the columned bodies and the first part of the supporting hub. Step S30 further comprises etching the columned bodies to form through vias which expose the bottom driving electrodes.

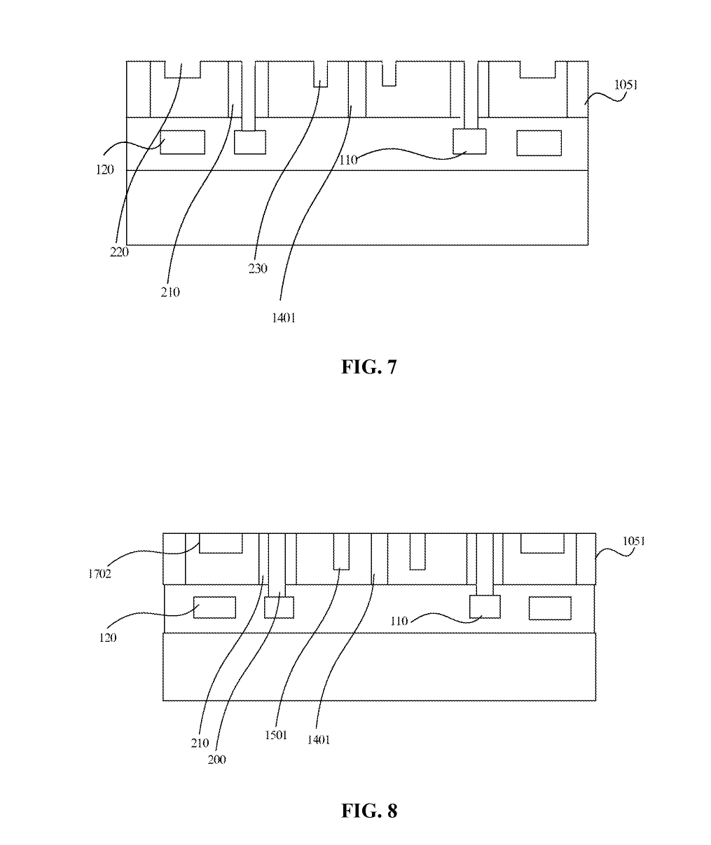

FIG. 7 schematically shows the structure formed by the step S30. Specifically, the step S30 comprises: etching the first sacrificial material which is provided over the second ring to form a first groove 220, and etching the first sacrificial material, which is provided between the first part of the supporting hub 1401 and the columned bodies 210 and close to the first part of the supporting hub 1401, to form a ring-typed second groove 230. The first groove 220 could be ring-typed. The depth ratio between the first groove 220 and the first sacrificial material ranges from one-third to two-third, such as 1 μm-3 μm. The width of the first groove 220 ranges from 0.3 μm-2 μm. The first groove 220 could also comprise a plurality of grooves distributed on a ring. Step S30 further comprises etching the columned bodies 210 to form through vias which expose the bottom driving electrodes 110 which are provided under the columned bodies 210.

Referring to FIG. 4, a step S40 comprises: depositing the first groove to form a weighting layer of a ring-typed planar inertia, depositing the second groove to form a first part of a supporting ring, and depositing the through vias to form conductive plugs.

FIG. 8 schematically shows the structure formed by the step S40. Deposit the first groove, the second groove and the through vias with metallic material by CVD, wherein the metallic material is tungsten, until they are completely filled. Next, remove unwanted metallic material until the top surface of the first groove, the second groove, the through vias and the first part of the supporting hub 1401 are in the same plane, whereby a weighting layer 1702 is formed at the location of the first groove, a first metallic layer 1501 of the supporting ring is formed at the location of the second groove, and the conductive plugs 200 are formed at the location of the through vias.

In other embodiments, the metallic layers in the first groove, the second groove and the through vias can be formed in different steps.

Referring to FIG. 4, a step S50 comprises: providing a first insulating layer at the top of the first metallic layer of the supporting ring and the weighting layer. The first insulating layer and the weighting layer constitute a ring-typed planar inertia. The first insulating layer and the first metallic layer constitute the supporting layer.

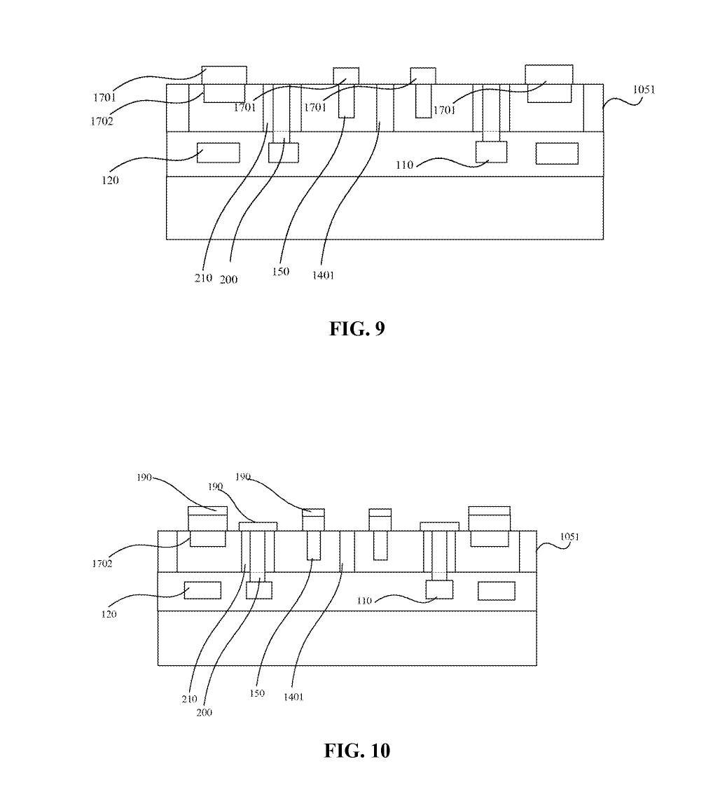

FIG. 9 schematically shows the structure formed by the step S50. The first insulating layer 1701 is provided at the top of the first metallic layer 1501 of the supporting ring and the weighting layer 1702. The first insulating layer 1701 and the weighting layer 1702 constitute the ring-typed planar inertia 170. The first insulating layer 1701 and the first metallic layer 1501 constitute the supporting layer 150. Specifically, an insulating material is formed by CVD after the step S40, wherein the insulating material is made of silicon oxide or silicon nitride, and the first insulating layer 1701 is formed by etching the insulating material.

Referring to FIG. 4, a step S60 comprises: providing suspending arms which connects the ring-typed planar inertia and the supporting ring, and providing elastic components between the ring-typed planar inertia and the supporting ring.

FIGS. 3b, 3c and 9 schematically show the structure formed by the step S60. Specifically, the step S60 and S50 could be finished at the same time. Suspending arms and elastic components could be formed by etching while etching the insulating layer. The suspending arms 160 are extended outwardly with equal altitude in radical direction by taking the supporting hub 150 as center. The suspending arms 160 connect the ring-typed planar inertia 170 to the supporting ring 150, and support the ring-typed planar inertia 170 suspending in the closed cavity 130. The planar inertia 170 is connected to the outside ends of the suspending arms 160 and having the supporting hub 140 as center. The elastic components 180 have the effect of recovery from stretching when the planar inertia 170 is rotating, and are distributed on a ring between the planar inertia and the supporting ring 150 having the supporting hub 140 as center. One end of every elastic component is connected to an adjacent suspending arm and the other end is free.

Referring to FIG. 4, a step S70 comprises: providing top driving electrodes at the top of the planar inertia 170, the suspending arms 160, the conductive plugs and the elastic components 180.

FIG. 10 schematically shows the structure formed by the step S70. The top driving electrodes 190 cover the planar inertia 170, the supporting ring 150, the suspending arms 160, and the elastic components 180. The top driving electrodes 190 which cover the planar inertia 170 and the supporting ring 150 are extended horizontally with equal altitude in radical direction by taking the suspending arms 160 as center, and the number thereof is corresponding to the suspending arms 160, and they are insulated to each other.

Referring to FIG. 4, a step S80 comprises: providing a second part of the supporting hub on the first part of the supporting hub and providing a second insulating layer on the first insulating layer. The first part and the second part of the supporting hub constitute the supporting hub.

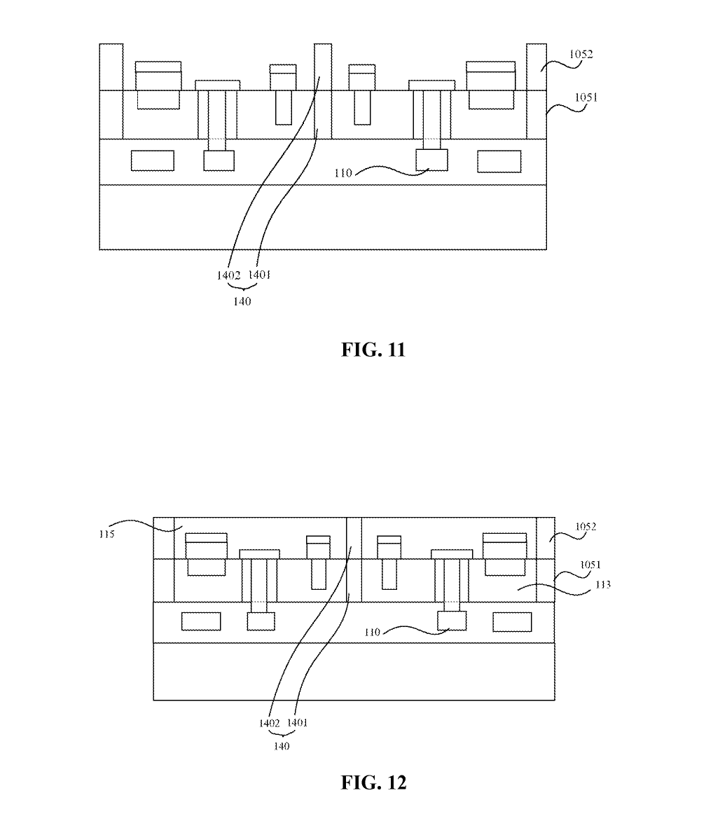

FIG. 11 schematically shows the structure formed by the step S80. The second part 1402 of the supporting hub is at the top of the first part 1401 of the supporting hub. The second insulating layer 1052 is at the top of the first insulating layer 1051. The first part 1401 and the second part 1402 of the supporting hub constitute the supporting hub 140.

Referring to FIG. 4, a step S90 comprises: providing a second sacrificial material at the top the first sacrificial material and the top driving electrodes.

FIG. 12 schematically shows the structure formed by the step S90. The second sacrificial material 115 is at the top the first sacrificial material 113 and the top driving electrodes 190. The second sacrificial material 115 could be made of the same material with the first sacrificial material 113.

Referring to FIG. 4, a step S100 comprises: providing a third dielectric insulating layer at the top of the second sacrificial material and the supporting ring. The third dielectric insulating layer comprises openings.

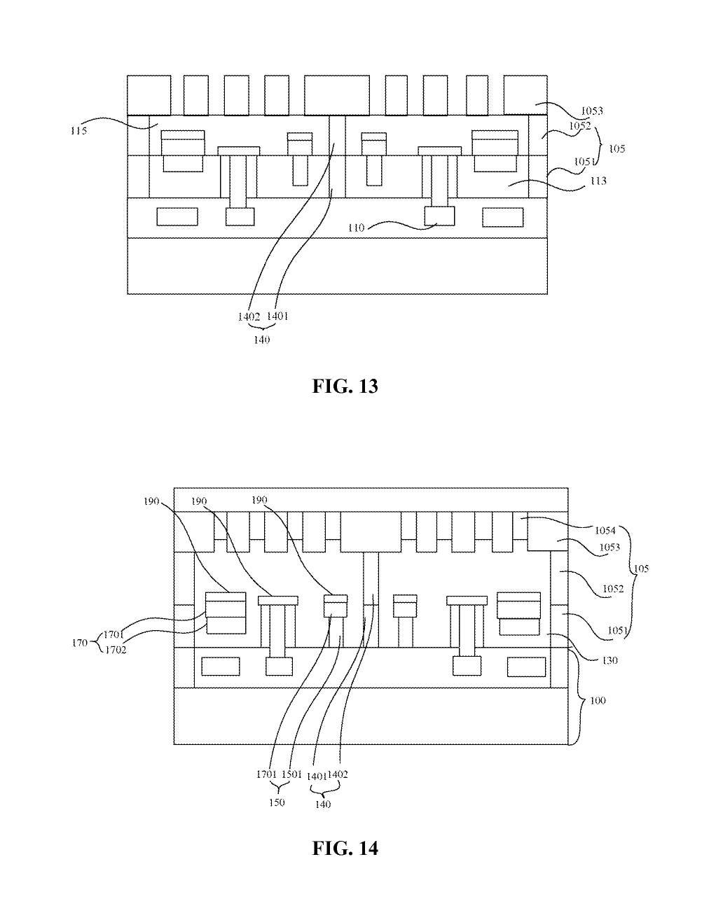

FIG. 13 schematically shows the structure formed by the step S100. Specifically, step S100 comprises the steps of providing the third dielectric insulating layer 1053 after the step S90, and etching the third dielectric insulating layer 1053 to form openings.

Referring to FIG. 4, a step S110 comprises: removing the first and second sacrificial material by utilizing the openings, and providing a fourth dielectric insulating layer at the top of the third dielectric insulating layer to form a closed cavity. The first dielectric insulating layer, the second dielectric insulating layer, the third dielectric insulating layer and the fourth dielectric insulating layer constitute the dielectric insulating layer.

FIG. 14 schematically shows the structure formed by the step S 110. The fourth dielectric insulating layer 105 is provided at the top of the third dielectric insulating layer 1053 to form the closed cavity. The first dielectric insulating layer 1051, the second dielectric insulating layer 1052, the third dielectric insulating layer 1053 and the fourth dielectric insulating layer 1054 constitute the dielectric insulating layer 105. Specifically, the first and second sacrificial materials are removed from the openings by ashing, and the fourth dielectric insulating layer 1054 is formed by CVD. The fourth dielectric insulating layer 1054 closes the cavity to form the closed cavity 130. So far, the fabricating of the gyroscope is done, shown in FIGS. 2 and 14. In this embodiment, the first and second sacrificial material are made of dense activated carbon by PECVD, the removing gas is oxygen, and temperature in the reaction ranges from 350 to 450° C. Under this temperature, the dense activated carbon will be oxidized to carbon dioxide, instead of intense burning, and then the carbon dioxide is exhausted by way of the through vias, whereby the first and second sacrificial material are removed completely, and other parts will not be affected. The fourth dielectric insulating layer 1054 is formed by CVD, and the reaction conditions comprise: a temperature ranging from 250 to 450° C., atmospheric pressure, and reaction gas including SiH4, O2 and N2 wherein the ratio between the O2 and SiH4 ranges from 2 to 5, and the flow rate ranges from 5 to 20 L/min.

According to method of fabricating a gyroscope in the present invention, after the formation of the first and second sacrificial materials, the gyroscope is fabricated in the first sacrificial material, the second sacrificial material and the substrate. Next, the third dielectric insulating layer with openings is provided at the top of the second sacrificial material, and the first and second sacrificial materials are removed by the openings. Next, the fourth dielectric insulating layer is provided at the top of the third dielectric insulating layer, and so far, the closed cavity is finished. The gyroscope fabricated in this method is closed in a closed cavity, and the stability and anti-environment noise capability are improved greatly.

Although the present invention has been disclosed as above with reference to preferred embodiments thereof but will not be limited thereto. Those skilled in the art can modify and vary the embodiments without departing from the spirit and scope of the present invention. Accordingly, the scope of the present invention shall be defined in the appended claims.

1. A gyroscope comprising:
a substrate comprising plural bottom driving electrodes and plural bottom measuring electrodes around the bottom driving electrodes;
a dielectric insulating layer provided on the substrate, comprising a closed cavity,
a supporting hub received in the closed cavity and arranged on the substrate;
a supporting ring arranged on the substrate and being able to rotate around the supporting hub;
a ring-typed planar inertia being around and having the same central axis with the supporting ring, and comprising a first insulating layer and a weighting layer under the first insulating layer;
plural suspending arms connecting the supporting ring to the ring-typed planar inertia, and supporting the ring-typed planar inertia suspending in the closed cavity;
plural elastic components surrounded by the supporting ring, the ring-typed planar inertia and two adjacent suspending arms;
plural top driving electrodes covering the supporting ring, the ring-typed planar inertia, the suspending arms and the elastic components; and
plural conductive plugs connecting the top driving electrodes which are arranged on the elastic components to the bottom driving electrodes.

2. The gyroscope according to claim 1, wherein the weighting layer is continuous ring-typed.

3. The gyroscope according to claim 1, wherein the weighting layer comprises a plurality of independent weighting columns distributed symmetrically on a ring.

4. The gyroscope according to claim 1, wherein weight of the weighting layer is greater than weight of the first insulating layer.

5. The gyroscope according to claim 1, wherein the weighting layer is made of tungsten.

6. The gyroscope according to claim 1, wherein the conductive plugs are made of tungsten.

7. The gyroscope according to claim 1, wherein the supporting ring comprises a supporting layer which is made of the same material with the weighting layer and a second insulating layer on the supporting layer, the second insulating layer and the first insulating layer being located in the same plane.

8. The gyroscope according to claim 1, wherein the suspending arms are extended outwardly with equal altitude and in radial direction from outside the supporting ring, and are suspended in the closed cavity.

9. The gyroscope according to claim 8, wherein one end of the elastic component connects to an adjacent suspending arm and the other end connects to a conductive plug.

10. The gyroscope according to claim 9, wherein the ring-typed planar inertia has the supporting hub as center, connects to free ends of the suspending arms, and is supported by the suspending arms for being suspended over the bottom measuring electrodes in the closed cavity.

11. The gyroscope according to claim 10, wherein the top driving electrodes cover the supporting ring, the ring-typed planar inertia, the suspending arms and the elastic components, wherein the top driving electrodes which are at the top of the supporting ring and the ring-typed planar inertia comprise four independent insulating parts, and connect to the bottom driving electrodes through the conductive plugs.

12. A method of fabricating a gyroscope described in claim 1, comprising:
providing a substrate, comprising plural bottom driving electrodes and plural bottom measuring electrodes, a first dielectric insulating layer being at the top of the substrate and comprising a ring-typed groove, a first part of a supporting hub being at the center of the ring-typed groove, and plural columned bodies being inside the ring-typed groove and at the top of the bottom driving electrodes;
depositing the ring-typed groove with a first sacrificial material until the top of the first sacrificial material and the columned bodies being in the same plane;
etching the first sacrificial material to form a first groove and a second groove inside the first sacrificial material, wherein the first groove is arranged over the ring formed by the bottom driving electrodes and the second groove is between the columned bodies and the first part of the supporting hub;
etching the columned bodies to form through vias which expose the bottom driving electrodes;
depositing the first groove to form a weighting layer of a ring-typed planar inertia, depositing the second groove to form a first part of a supporting ring, and depositing the through vias to form conductive plugs;
providing a first insulating layer on the supporting ring and the weighting layer, the first insulating layer and the weighting layer constituting the ring-typed planar inertia, and the first insulating layer and the first part of the supporting layer constituting the supporting ring;
providing at least a suspending arm which connects the ring-typed planar inertia and the supporting ring, the suspending arms being extended outwardly with equal altitude in radical direction by taking the supporting hub as center, and providing plural elastic components between the ring-typed planar inertia and the supporting ring;
providing plural top driving electrodes covering the ring-typed planar inertia, suspending arms, conductive plugs and the elastic components;
providing a second part of the supporting hub at the top of the first part of the supporting hub, and the first part and the second part of the supporting hub constituting the supporting hub;
providing a second insulating layer on the first insulating layer;
providing a second sacrificial material at the top the first sacrificial material and the top driving electrodes;
providing a third dielectric insulating layer at the top of the second sacrificial material and the supporting ring, and the third dielectric insulating layer comprising openings;
removing the first and second sacrificial material by utilizing the openings, and providing a fourth dielectric insulating layer at the top of the third dielectric insulating layer to form a closed cavity.

13. The method of fabricating a gyroscope according to claim 12, wherein the first groove is ring-typed.

14. The method of fabricating a gyroscope according to claim 12, wherein the first groove comprises a plurality of grooves symmetrically distributed on the ring.

15. The method of fabricating a gyroscope according to claim 12, wherein the weighting layer is made of tungsten.

16. The method of fabricating a gyroscope according to claim 12, wherein depositing the first groove to form the weighting layer, depositing the second groove to form the first part of the supporting ring and depositing the vias to form the conductive plugs could be finished in one process.

17. A ring-typed planar inertia comprising a first insulating layer and a weighting layer under the first insulating layer.

18. The gyroscope according to claim 17, wherein the weighting layer is continuous ring-typed or comprises a plurality of independent weighting columns distributed symmetrically on a ring.

19. The gyroscope according to claim 17, wherein the weight of the weighting layer is greater than the weight of the first insulating layer.

20. The gyroscope according to claim 17, wherein the weighting layer is made of tungsten.
